(19) United States
(12) Patent Application Publication
(10) Pub. No.: US 2014/0007118 A1
(43) Pub. Date: Jan. 2, 2014

(54) COMPARISON DEVICE, COMPARISON METHOD, NON-TRANSITORY RECORDING MEDIUM, AND SYSTEM

(71) Applicant: Konami Digital Entertainment Co., Ltd., Tokyo (JP)

(72) Inventor: Tahei Katagai, Minato-ku (JP)

(21) Appl. No.: 13/925,370

(22) Filed: Jun. 24, 2013

(30) Foreign Application Priority Data
Jun. 27, 2012 (JP) 2012-144539

(51) Int. Cl. G06F 9/54

(52) U.S. Cl. CPC G06F 9/54
USPC 718/102

(57) ABSTRACT

A task presenter presents a task to a first user. An acquirer acquires a first action taken by the first user while the task is presented to the first user. A reader reads a second action taken by a second user to the task from a storage. An action presenter presents the first action and the second action to the first user in a comparative manner. A writer writes to the storage the first action as the action taken by the first user to the task.

### CROSS-REFERENCE TO RELATED APPLICATION

This application claims the benefit of Japanese Patent Application No. 2012-144539, filed on Jun. 27, 2012, the entire disclosure of which is incorporated by reference herein.

### TECHNICAL FIELD

This application relates to a comparison device, a comparison method, a non-transitory recording medium, and a system preferable for comparing the action of a user with the action of a third party.

### BACKGROUND ART

In the prior art, network systems comparing the action of a user with the action of another user are known. In such a system, first, a user has to select a person to compare among various other registered users. For example, Unexamined Japanese Patent Application Kokai Publication No. 2012-34822 discloses a technique of matching among multiple terminal devices communicably connected via the Internet.

A problem with the above system is that comparison with a person with an equal level of skill or attribute is not easy because there are a limited number of such persons.

The present invention solves the above problem and an objective of the present invention is to provide a comparison device, a comparison method, a non-transitory recording medium, and a system preferable for comparing the action of a user with the action of a third party.

### SUMMARY

The comparison device according to a first exemplary aspect of the present invention comprises:

a task presenter presenting a task to a first user;

an acquirer acquiring a first action taken by the first user while the task is presented to the first user;

a reader reading a second action taken by a second user to the task from a storage;

an action presenter presenting the first action and the second action to the first user in a comparative manner; and

a writer writing to the storage the first action as the action taken by the first user to the task.

Furthermore, the above comparison device further comprises a selector selecting a first object for the first user and a second object for the second user, wherein:

the action presenter presents the first object and the second object along with the first action and the second action.

Furthermore, in the above comparison device,

the selector selects the first object from a group of first objects associated with the first user under a first rule, and

selects the second object from a group of second objects associated with the second user under a second rule.

Furthermore, the above comparison device further comprises an evaluator determining an evaluation value of the first user and an evaluation value of the second user based on the first action and the first object and the second action and the second object.

Furthermore, in the above comparison device,

the task comprises multiple ordered partial tasks, and

the action presenter repeats the processing of presenting parts of the first action and the second action that correspond to a partial task in the comparative manner after the task presenter presents the partial task.

The comparison method according to a second exemplary aspect of the present invention is a comparison method executed by a comparison device comprising a task presenter, an acquirer, a reader, an action presenter, and a writer, comprising:

a task presentation step in which the task presenter presents a task to a first user;

an acquisition step in which the acquirer acquires a first action taken by the first user while the task is presented to the first user;

a reading step in which the reader reads a second action taken by a second user to the task from a storage;

an action presentation step in which the action presenter presents the first action and the second action to the first user in a comparative manner; and

a writing step in which the writer writes to the storage the first action as the action taken by the first user to the task.

The computer-readable non-transitory recording medium according to a third exemplary aspect of the present invention records the program that allows a computer to function as:

a task presenter presenting a task to a first user;

an acquirer acquiring a first action taken by the first user while the task is presented to the first user;

a reader reading a second action taken by a second user to the task from a storage;

an action presenter presenting the first action and the second action to the first user in a comparative manner; and

a writer writing to the storage the first action as the action taken by the first user to the task.

The system according to a fourth exemplary aspect of the present invention is a system including a terminal device and a server device communicable with the terminal device, wherein either the terminal device or the server device comprises:

a task presenter presenting a task to a first user;

an acquirer acquiring a first action taken by the first user while the task is presented to the first user;

a reader reading a second action taken by a second user to the task from a storage;

an action presenter presenting the first action and the second action to the first user in a comparative manner; and

a writer writing to the storage the first action as the action taken by the first user to the task.

Here, the non-transitory recording medium means a tangible recording medium. The non-transitory recording medium is, for example, a compact disc, a flexible disc, a hard disc, a magneto-optical disc, a digital video disc, a magnetic tape, a semiconductor memory, or the like. On the other hand, a transitory recording medium means a transfer medium (propagation signals) itself. The transitory recording medium is, for example, electric signals, optical signals, electromagnetic waves, or the like. Incidentally, a temporary storage area is an area temporarily storing data and/or programs and, for example, a volatile memory such as a RAM (Random Access Memory).

The above programs can be distributed/sold independently from a computer on which the programs run via computer communication networks. Furthermore, the above non-transitory recording medium can be distributed/sold independently from the computer.

The present invention can provide a comparison device, a comparison method, a non-transitory recording medium, and a system preferable for comparing the action of a user with the action of a third party.

### BRIEF DESCRIPTION OF THE DRAWINGS

A more complete understanding of this application can be obtained when the following detailed description is considered in conjunction with the following drawings, in which:

FIG. 1 is an illustration showing the system configuration according to an embodiment;

FIG. 2 is a diagram showing the general configuration of a typical information processing device;

FIG. 3 is an illustration for explaining a rhythm game;

FIG. 4 is a diagram showing the general configuration of the comparison device according to Embodiment 1;

FIG. 5 is an illustration for explaining the action data table;

FIG. 6 is an illustration showing how the first action and the second action are presented in a comparative manner;

FIG. 7 is an illustration for explaining the action data table;

FIG. 8 is a flowchart for explaining the processing executed by the components of the comparison device according to Embodiment 1;

FIG. 9 is a diagram showing the general configuration of the comparison device according to Embodiment 2;

FIG. 10 is an illustration showing how the first action and the first object are presented;

FIG. 11 is an illustration for explaining the object table;

FIG. 12 is an illustration showing how the first action and the first object and the second action and the second object are presented;

FIG. 13 is a flowchart for explaining the processing executed by the components of the comparison device according to Embodiment 2;

FIG. 14 is a flowchart for explaining the processing executed by the components of the comparison device according to Embodiment 3;

FIG. 15 is a diagram showing the general configuration of the comparison device according to Embodiment 4; and

FIG. 16 is a flowchart for explaining the processing executed by the components of the comparison device according to Embodiment 4.

### DETAILED DESCRIPTION

The following embodiments are given for the purpose of explanation and do not confine the scope of the invention of the present application. A person of ordinary skill in the field may embrace an embodiment in which some or all elements are replaced with equivalent counterparts. Such an embodiment falls under the scope of the present invention.

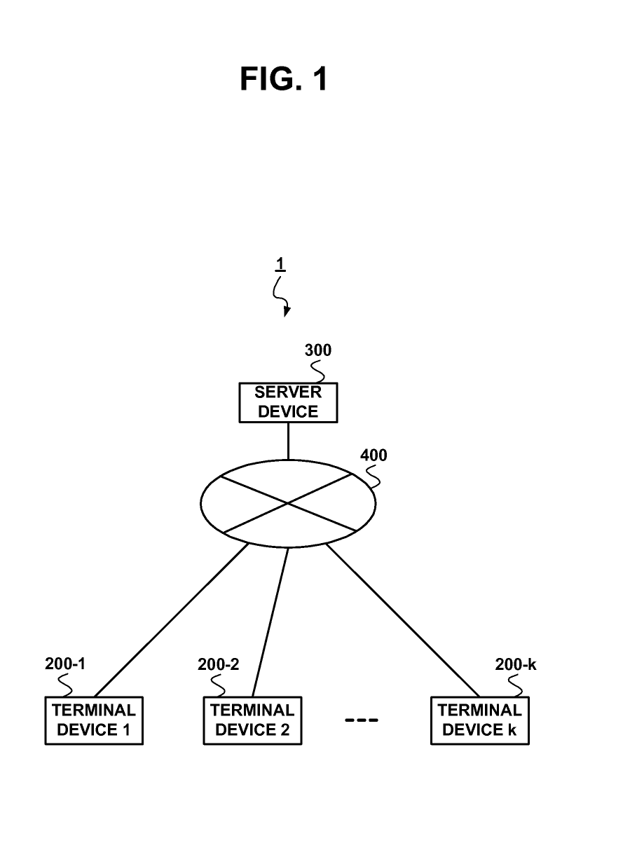

The comparison device of the present invention is applicable, for example, to a system 1 shown in FIG. 1.

The system 1 comprises terminal devices 200-1 to 200-k (k is an integer equal to or greater than 1; the terminal device 200, hereafter) and a server device 300. The terminal device 200 and the server device 300 are connected via the Internet 400.

In the system 1, the comparison device is realized, for example, by the terminal device 200. Alternatively, the comparison device can be realized by the server device 300. Alternatively, the terminal device 200 and the server device 300 can take partial charge of the functions of the comparison device so that the comparison device is realized by the terminal device 200 and the server device 300.

### General Configuration of Information Processing Device

An information processing device 10 realizing the terminal device 200 or the server device 300 of an embodiment will be described hereafter.

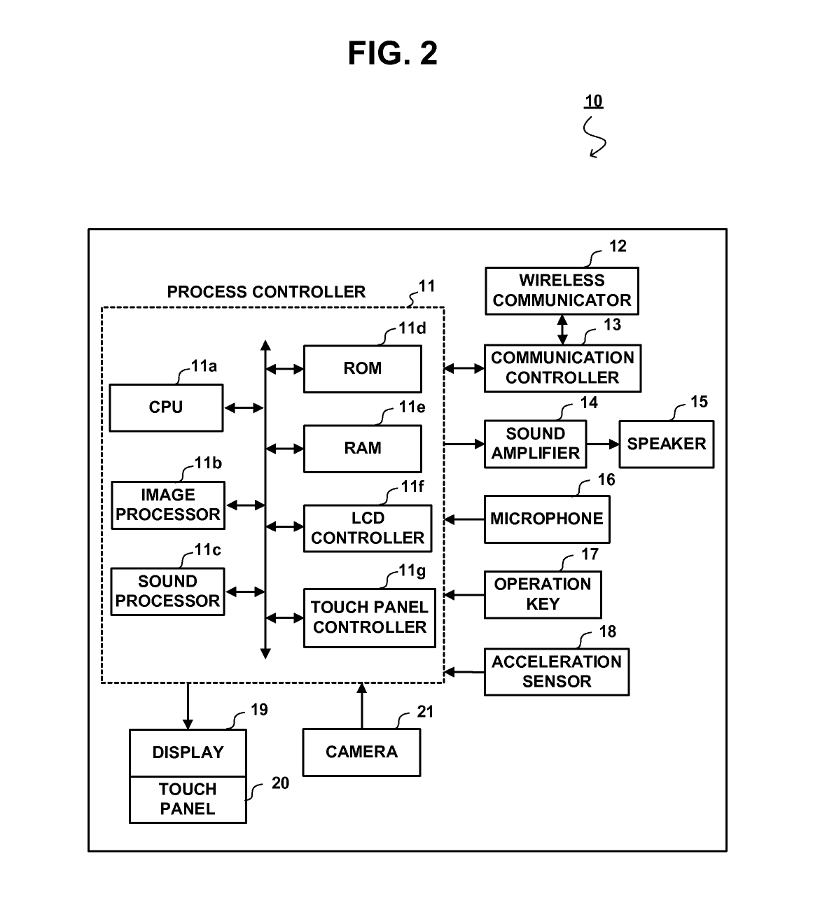

FIG. 2 is a schematic diagram showing the general configuration of a typical information processing device 10 realizing the comparison device according to an embodiment of the present invention by executing the programs. The following explanation will be made with reference to the figure.

The information processing device 10 comprises a process controller 11, a wireless communicator 12, a communication controller 13, a sound amplifier 14, a speaker 15, a microphone 16, an operation key 17, an acceleration sensor 18, a display 19, a touch panel 20, and a camera 21.

The process controller 11 comprises a CPU (Central Processing Unit) 11a, an image processor 11b, a sound processor 11c, a ROM (Read Only Memory) 11d, a RAM (Random Access Memory) 11e, an LCD controller 11f, and a touch panel controller 11g.

The CPU 11a is connected to the components of the information processing device 10 and controls the entire operation of the information processing device 10. Furthermore, the CPU 11a exchanges control signals and data with the components of the information processing device 10.

The image processor 11b processes, for example, image data read from the ROM 11d, image data captured by the camera 21, or image data processed by the CPU 11a and stores these image data in the RAM 11e. Here, it is possible to directly output the image data and the like from the image processor 11b to the display 19.

The sound processor 11c processes, for example, sound data read from the ROM 11d and/or music data processed by the CPU 11a and stores these data in the RAM 11e. Here, it is possible to directly output the sound data and the like from the sound processor 11c to the sound amplifier 14.

The ROM 11d stores, for example, control programs, data, and the like necessary for selecting an item or the like displayed on the display 19. The control programs, data, and the like are output to the CPU 11a, RAM 11e, and the like.

The RAM 11e stores image data processed by the image processor 11b for display, work data for the CPU 11a to execute various procedures according to the programs, and/or the like, and outputs these data and/or the like to the CPU 11a, display 19, and the like.

The LCD controller 11f controls the display 19 to display given display images. For example, the LCD controller 11f converts image data stored in the RAM 11e to display signals at given synchronized times and outputs the display signals to the display 19. Furthermore, the LCD controller 11f displays given selection buttons and the like on the display 19.

The touch panel controller 11g senses/detects contact (touch operation) of a touch pen or a finger of the user to the touch panel 20. For example, the touch panel controller 11g senses contact to or release (separation) from the touch panel 20 while the given selection buttons and the like are displayed on the display 19 and detects the position of the contact or release.

The wireless communicator 12 is a unit for wireless communication with the wireless communicators of other information processing devices, and transmits/receives given data via a built-in antenna (not-shown) in the information processing device 10. The wireless communicator 12 can wireless-communicate also with a given access point. Furthermore, the wireless communicator 12 is given a unique MAC (media access control) address.

The communication controller 13 controls the wireless communicator 12 and mediates wireless communication between the process controller 11 and other information processing devices. Furthermore, when the information processing device 10 is connected to the Internet via a nearby wireless access point or the like, the communication controller 13 mediates wireless communication with the wireless access point or the like according to a wireless LAN (Local Area Network)-compliant protocol.

The sound amplifier 14 amplifies the sound signals generated by the process controller 11 and supplies the sound signals to the speaker 15. The speaker 15 is, for example, a stereo speaker or the like and outputs given sound effects and/or music sound, voice sound and the like according to the sound signals amplified by the sound amplifier 14.

The microphone 16 receives analog signals such as the user's voice and the received signals are processed, for example mixed, by the sound processor 11c.

The operation key 17 comprises key switches and the like properly provided on the information processing device 10, and receives input of given instruction such as on/off of the information processing device 10 according to the operation.

The acceleration sensor 18 is built in the information processing device 10 and measures the triaxial motion of the information processing device 10. For example, the acceleration sensor 18 measures the shift/rotation of the information processing device 10 caused by the user. The measurement results are supplied to the process controller 11 and used in the procedure to create image data and the like. Here, an angular acceleration sensor or tilt sensor can be used to measure the motion of the information processing device 10 in place of the acceleration sensor 18.

The display 19 comprises an LCD or the like and properly displays given selection buttons and the like under the control of the LCD controller 11f.

The touch panel 20 is superimposed on the front face of the display 19 and receives input by means of a touch pen or a finger of the user. The touch panel 20 is, for example, a pressure-sensitive touch panel, sensing the pressure from a touch pen or the like and detecting a touch operation such as contact and the position of the touch operation (touch position). Here, the touch panel 20 can be, for example, the one sensing/detecting contact of a finger of the user based on change in the capacitance.

The camera 21 photographs a surrounding space according to instruction from the user and converts the photographed image to electric signals. The camera 21 comprises, for example, a CMOS (Complimentary MOS) sensor and the like.

### Outline of Game

An exemplary game to which the comparison device according to the embodiment is applicable will be described. The game described below is a rhythm game requiring given actions in time to the music reproduced. The music used in the rhythm game is stored in the information processing device 10 or distributed through the network. Here, the game to which the comparison device of the present application is applicable is not limited to the rhythm game. For example, the comparison device of the present application is applicable to the games presenting tasks that call for user operation such as quiz games and action games.

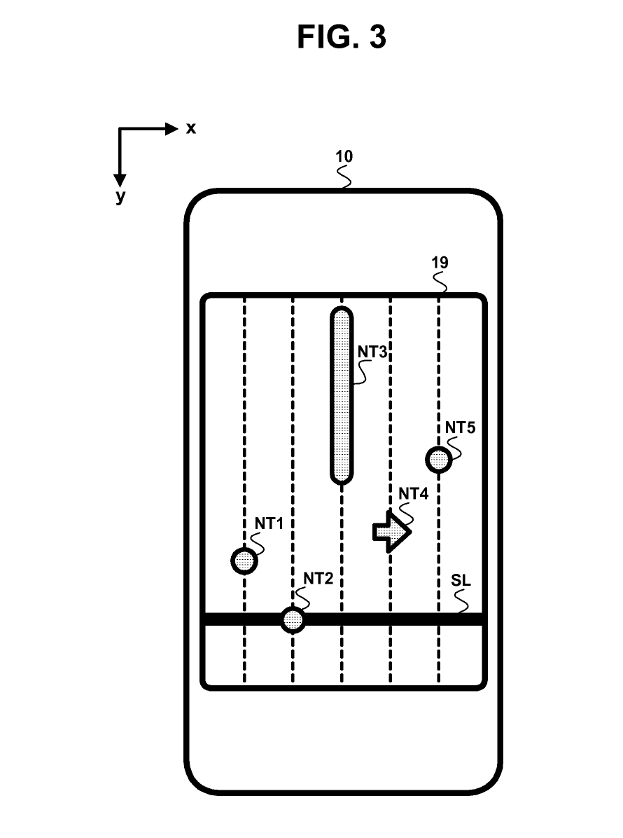

FIG. 3 shows a game image of the rhythm game. The game image of the rhythm game includes multiple kinds of notes NTm (m=1 to M; arbitrary M) and a reference line SL. The notes NTm successively appear from above in the y-axis direction and move downward or appear from below in the y-axis direction and move upward in synchronization with the rhythm of the music reproduced or the like. The reference line SL moves in the y-axis direction or tilted with respect to the x-axis depending on the degree of difficulty of the game. Here, the moving direction of the notes is not limited to the vertical direction; the notes may move in any direction including the horizontal direction.

The music is, for example, stored in the information processing device 10 and selected according to instruction from the user or randomly. The data for the notes NTm to be placed in synchronization with the rhythm of the music are prepared in advance. Here, the notes NTm are automatically reproduced regarding the selected music or are created by the user on an arbitrary basis. For example, selecting the mode to create notes NTm, the user executes operation such as tapping and flicking on the touch panel 20 to create the notes NTm corresponding to the operation and stores the notes NTm in association with the music.

The notes NTm are in multiple kinds of shape; the shape is associated with the action required for the user. For example, the notes NT1, NT2, and NT5 require tapping the note displayed on the screen. The note NT3 requires pressing and holding the note for the length of the note. The note NT4 requires flicking the note displayed on the screen in the arrowed direction. Additionally, some note NTm requires tracing the screen.

When a note NTm overlaps with the reference line SL (“the time of overlap”), the user is required to take an action indicated by the note NTm. In other words, when the note NT2 overlaps with the reference line SL, the user is required to tap the screen. Similarly, when the note NT3 overlaps with the reference line SL, the user is required to press and hold for the length of the note NT3. Furthermore, when the note NT4 overlaps with the reference line SL, the user is required to flick the screen to the right (in the positive x-axis direction).

If the user executes the operation indicated by the note NTm at the time of overlap, some score is added. On the other hand, if the user executes no operation or fails to execute the operation indicated by the note NTm properly at the time of overlap, no score is added or some score is reduced. Here, a higher score may be given when the error between the operation time and time of overlap is smaller.

The general configuration of the comparison device of the embodiment realized by the above-described information processing device 10 will be described hereafter with reference to FIGS. 1 to 16.

### General Configuration of Comparison Device According to Embodiment 1

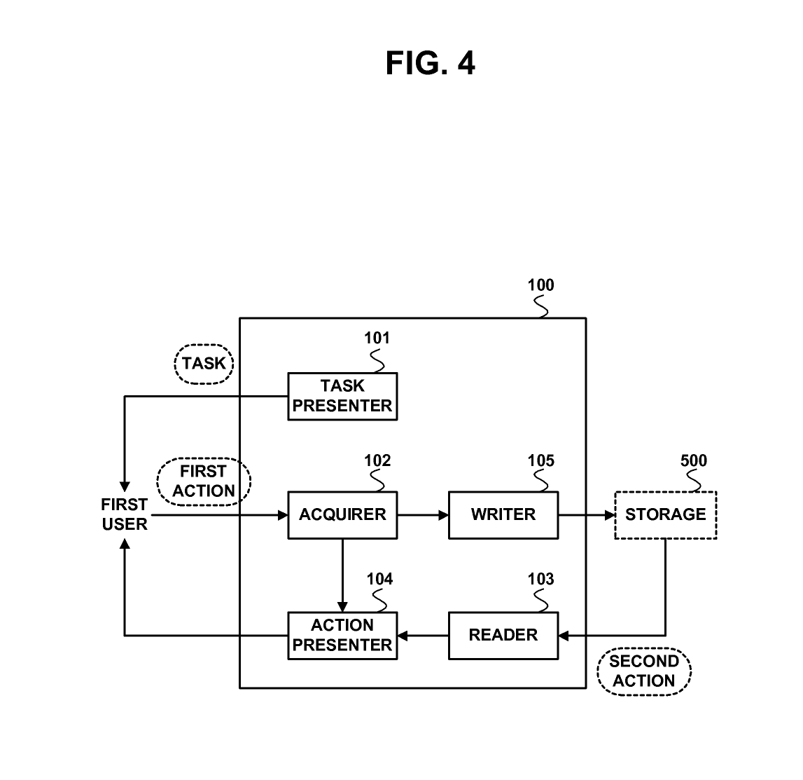

A comparison device 100 according to Embodiment 1 comprises, as shown in FIG. 4, a task presenter 101, an acquirer 102, a reader 103, an action presenter 104, and a writer 105.

The task presenter 101 presents a task to a first user.

The task means, for example, the rhythm game requiring operation indicated by the notes NTm in rhythm to music as shown in FIG. 3. Here, the task is not limited to the rhythm game. For example, the task can be any game as long as the game requires user operation such as a dance game and karaoke. The task is stored in the terminal device 200 operated by the first user or in the server device 300 accessible by the terminal device 200. Furthermore, when the task is something using music such as the rhythm game, the music can be stored either in the terminal device 200 or in the server device 300. When the music is stored in the server device 300, the terminal device 200 accesses the server device 300 to acquire the music and then the task presenter 101 presents the task.

The task presenter 101 displays on the display 19 the notes NTm or reference line SL moving in time with music. The task presentation means by the task presenter 101 is not limited thereto. It is possible to present a task by displaying on the display 19 the notes NTm moving toward any object included in the game image or in any direction.

In this embodiment, the process controller 11 and the display 19 cooperate to function as the task presenter 101. This applies to the embodiments below.

The acquirer 102 acquires a first action taken by the first user while the task is presented to the first user.

For example, it is assumed that a rhythm game “MUSIC 1” is presented to a user A (the first user). If the user A executes operation such as tapping according to the notes NTm displayed on the screen while the rhythm game “MUSIC 1” is presented, the acquirer 102 acquires information on the operation position and time as the first action. The information on the position and time of operation such as tapping executed by the user is referred to as “the action data” hereafter. Here, besides the operation on the touch panel such as tapping, the first action acquired by the acquirer 102 can be operation detected by an infrared sensor, button operation, voice input, and the like.

In this embodiment, the process controller 11 and the touch panel 20 cooperate to function as the acquirer 102. This applies to the embodiments below.

The reader 103 reads a second action taken by a second user to the task from a storage 500.

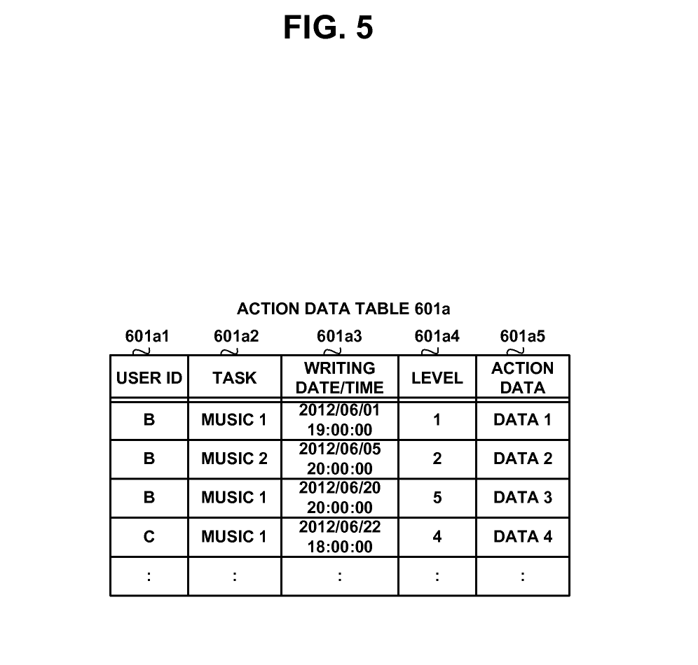

Here, it is assumed that the storage 500 is a RAM provided to the server device 300. The storage 500 stores the second action taken by the second user to the task. The storage 500 further stores information regarding the second action, for example, as an action data table 601a (FIG. 5). The storage 500 is not limited to a single storage and can be multiple storages. Furthermore, when the task uses music and the music is stored in the terminal device 200, the user is able to work on the task without communication with the server device 300.

In the action data table 601a, a user ID 601a1, a task 601a2, writing date/time 601a3, a level 601a4, and action data 601a5 are associated and registered.

The user ID 601a1 is used to identify the user. For example, the user ID “B” indicates a user B.

The task 601a2 is used to identify the task the user worked on. For example, “MUSIC 1” is a music title of the rhythm game.

The writing date/time 601a3 indicates the date/time when the writer 105, which will be described later, wrote the action data. For example, the first line of the table in FIG. 5 indicates that “DATA 1” are written at 19:00 on Jun. 1, 2012.

The level 601a4 is a value indicating the grade of the action data. As the numeric value is higher, the grade of the action data is higher. For example, the level ranges from 1 to 10 in value. The grade of “DATA 1” is the lowest one.

The action data 601a5 are data presenting the action taken by the user to the task. For example, the “DATA 1” includes information on the position and time of operation such as tapping in the rhythm game “MUSIC 1.”

The reader 103 is connected to the storage 500, for example, via the Internet and makes reference to the action data table 601a to read the action data regarding the “MUSIC 1” played by the user. For example, in the case of the action data table 601a in FIG. 5, the action data regarding the “MUSIC 1” include “DATA 1,” “DATA 3,” and “DATA 4.” When there are multiple data as in this case, it is possible to allow the first user to select or to automatically select the one close in grade (level) to the first action of the first user. For example, the reader 103 reads the action data “DATA 1” taken by the user B to the “MUSIC 1” from the storage 500.

In this embodiment, the process controller 11, wireless communicator 12, and communication controller 13 cooperate to function as the reader 103. This applies to the embodiments below.

The action presenter 104 presents the first action and the second action to the first user in a comparative manner.

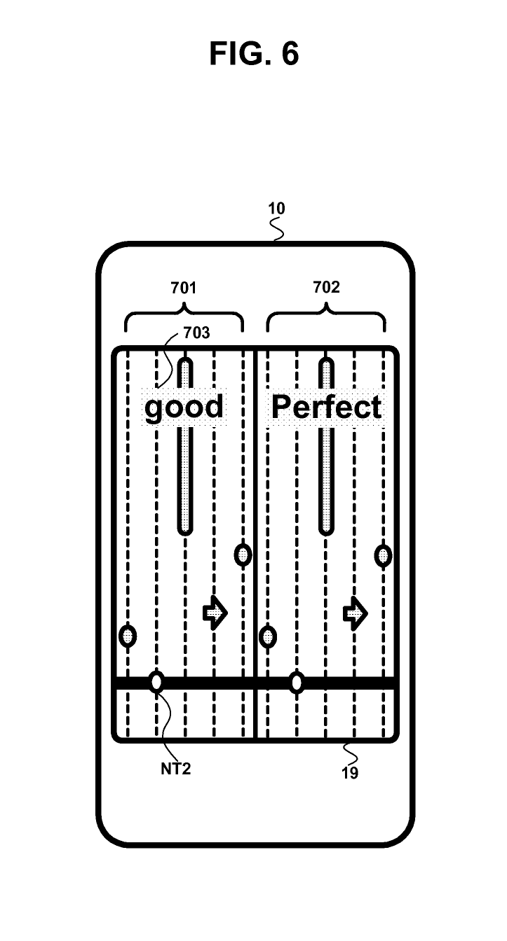

For example, it is assumed that the action data “DATA 1” of the user B are read. In such a case, the action presenter 104 displays action data 701 of the user A and action data 702 of the user B on the display 19 in the comparative manner as shown in FIG. 6. As the user executes operation such as tapping on a note NTm, the note NTm is displayed differently in color or brightness from the other notes, for example, like the note NT2, and the evaluation 703 of the operation is displayed.

In this embodiment, the process controller 11 and the display 19 cooperate to function as the action presenter 104. This applies to the embodiments below.

The writer 105 writes to the storage 500 the first action as the action taken by the first user to the task.

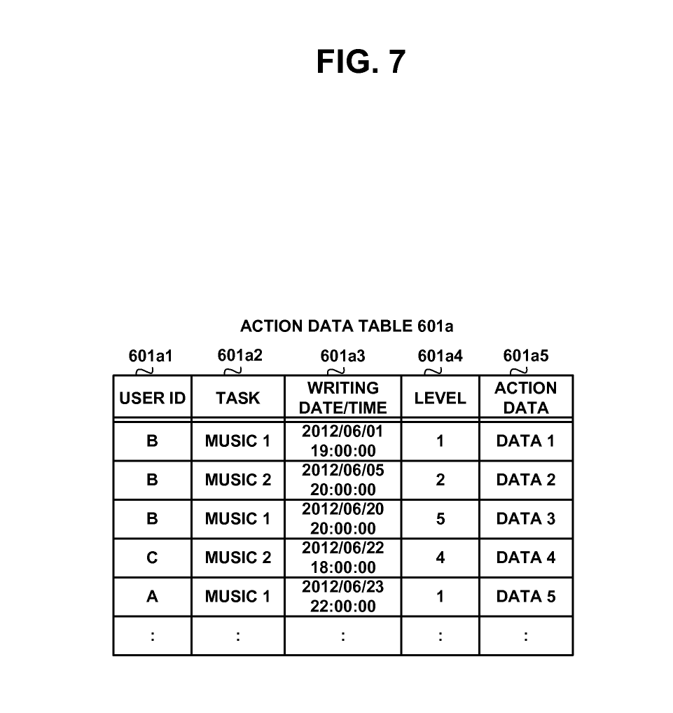

For example, it is assumed that the user A finished the rhythm game “MUSIC 1” at 22:00 on Jun. 23, 2012. The writer 105 writes the action data of the user A to the RAM of the server device 300 and associates and registers the user ID “A” of the user A, the task “MUSIC 1,” the writing date/time, the level “1” of the action data of the user A to the “MUSIC 1,” and the action data “DATA 5” in the action data table 601a as shown in FIG. 7.

In this embodiment, the process controller 11, the wireless communicator 12, and the communication controller 13 cooperate to function as the writer 105. This applies to the embodiments below.

With this embodiment, comparing with the past action of other user who worked on the same task, the user can check on his/her own action to the task. Then, the user can make reference to the data of the other user when he/she was at a nearly equal level of skill or attribute to the user and have more options in selecting the data to compare. For example, when a user who is inexperienced with a game competes with other user and there is skill difference from the other user who is available for comparison, the inexperienced user cannot win against the other user and it is difficult to continue the game. However, with this embodiment, the action data of the other user when he/she was still inexperienced with the game can be made reference to in competition. This prevents the user from giving up the game because there is no proper opponent and the user is urged to continue the game.

### Operation of Comparison Device According to Embodiment 1

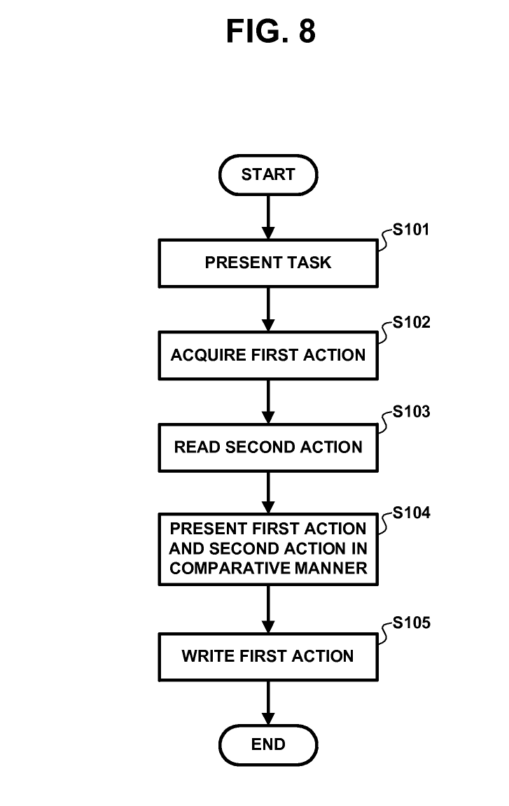

Operation of the comparison device 100 according to the embodiment will be described hereafter. When the comparison device 100 is powered on, the comparison device 100 executes the procedure shown in the flowchart of FIG. 8. The processing in each step will be described hereafter.

As the user specifies a task, the task presenter 101 presents the task to the first user (Step S101).

For example, as the user A specifies the rhythm game “MUSIC 1,” the game starts and the task presenter 101 displays the rhythm game image on the display 19 as shown in FIG. 3.

The acquirer 102 acquires the first action taken by the first user while the task is presented to the first user (Step S102).

For example, the acquirer 102 acquires information on the operation such as tapping and flicking executed by the user A while the notes NTm are displayed on the display 19.

The reader 103 reads the second action taken by the second user to the task from the storage 500 (Step S103).

For example, after the user A finished the operation on the game “MUSIC 1,” the reader 103 makes reference to the action data table 601a and reads information on the operation taken by other user to the “MUSIC 1.” For example, the reader 103 reads the “DATA 1” of the user B from the storage 500.

The action presenter 104 presents the first action and the second action to the first user in the comparative manner (Step S104).

For example, the action presenter 104 displays the action data of the user A and the action data of the user B (DATA 1) in regard to the “MUSIC 1” in the comparative manner as shown in FIG. 6.

The writer 105 writes to the storage 500 the first action as the action taken by the first user to the task (Step S105).

For example, the writer 105 writes to the RAM of the server device 300 the action data of the user A to the rhythm game “MUSIC 1,” and registers information regarding the action data in the action data table 601a as shown in FIG. 7.

Here, the order of the processing executed by the comparison device 100 is not limited to the order shown in the flowchart of FIG. 8. For example, the reader 103 may read the second action immediately after the user specifies the task. In such a case, it is possible to start presenting the second action at the same time as the task is presented to the first user and present the first action and the second action in the comparative manner. This mode gives a feeling of real-time comparison with the data of the second user. Furthermore, for example, the processing of the writer 105 may be executed before the reader 103 reads the second action.

### General Configuration of Comparison Device According to Embodiment 2

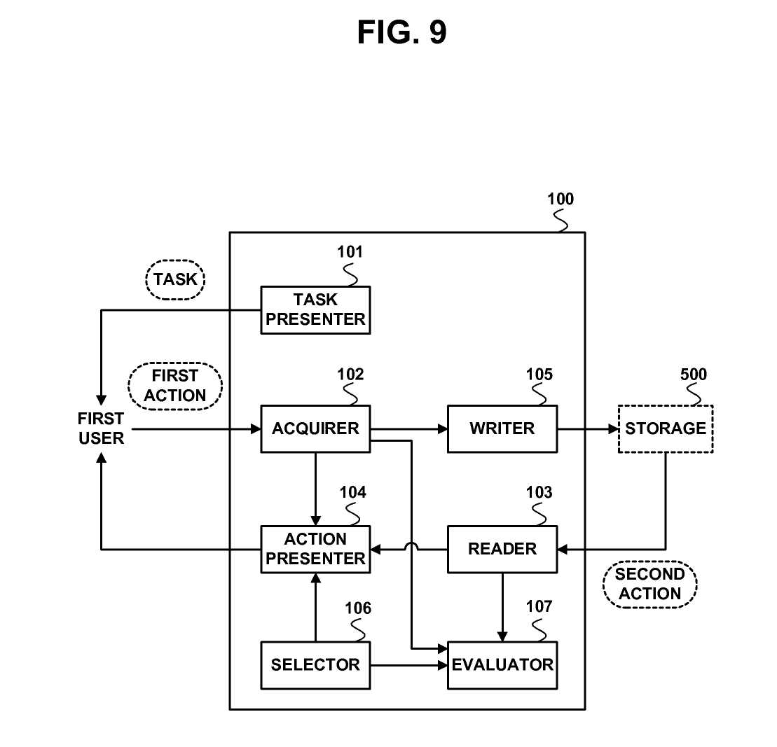

The comparison device 100 according to Embodiment 2 comprises, as shown in FIG. 9, a task presenter 101, an acquirer 102, a reader 103, an action presenter 104, a writer 105, a selector 106, and an evaluator 107.

The task presenter 101, the acquirer 102, the reader 103, and the writer 105 of this embodiment have the same functions as those of Embodiment 1. The action presenter 104, the selector 106, and the evaluator 107 having different functions will mainly be described hereafter.

The selector 106 selects a first object for the first user and a second object for the second user.

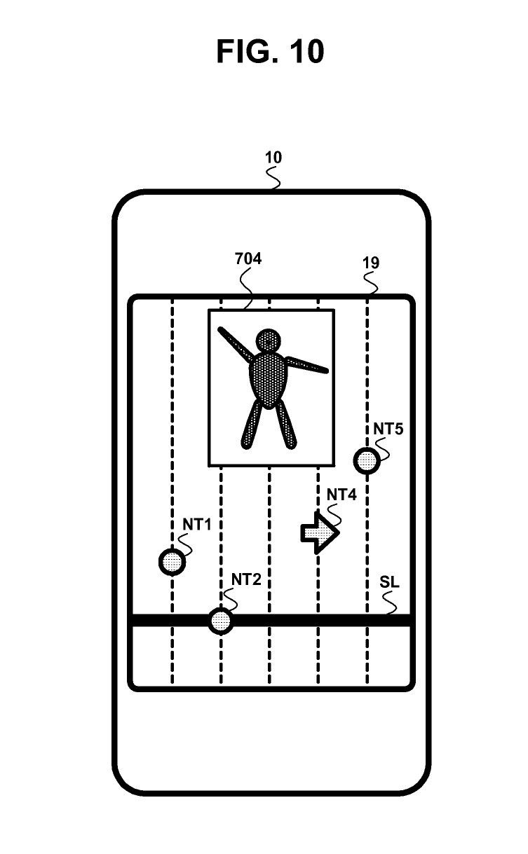

The first object is, for example, a card acquired by the first user and the second object is a card acquired by the second user in a rhythm game. The cards are given scores depending on their nature and presented during the rhythm game. For example, as shown in FIG. 10, a card 704 is displayed on the display 19 along with the notes NTm. Here, the first and second objects are not limited to the above example as long as they are associated with the first and second users. For example, the object can be any object acquired in a game (for example, a SNS (Social Networking Service) game) different from the game the user is currently playing or any object given to the user randomly once a day.

Here, the selector 106 selects the first object from a group of first objects associated with the first user under a first rule and the second object from a group of second objects associated with the second user under a second rule.

The objects associated with a user are registered, for example, in an object table 602a. The object table 602a is stored, for example, in a device different from the comparison device 100 such as the storage 500. Alternatively, the user may store those associated with his/her own user ID in a storage of the terminal device 200 he/she operates. In such a case, the user can work on the task without communication with the server device 300.

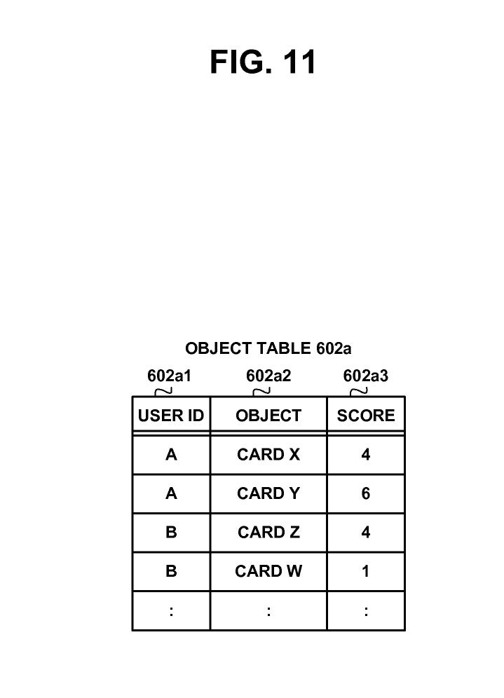

For example, as shown in FIG. 11, a user ID 602a1, an object 602a2, and a score 602a3 are associated and registered in the object table 602a.

The user ID 602a1 is used to identify the user. For example, the user ID “A” indicates the user A.

The object 602a2 is used to identify the object associated with the user. For example, in the object table 602a of FIG. 11, “CARD X” and “CARD Y” associated with the user A (the first user) are the objects constituting the group of first objects. Furthermore, “CARD Z” and “CARD W” associated with the user B (the second user) are the objects constituting the group of second objects.

The score 602a3 is the score associated with the object. An evaluation value, which will be described later, is obtained based on the score.

The first rule is the rule to select the first object from the group of first objects and the second rule is the rule to select the second object from the group of second objects. The first and second rules are, for example, random, the descending order of score, the ascending order of score, or rules defined by the users as appropriate.

For example, the selector 106 makes reference to the object table 602a and selects any card randomly from the “CARD X” and “CARD Y” for the user A and selects the card from the “CARD Z” and “CARD W” in the ascending order of score for the user B.

Here, the first and second rules are not necessarily different as described above and can be the same rule.

Furthermore, the selector 106 selects the first object and the second object in the following timely manner.

For example, the time of selection is determined based on the timing and quantity of the presented task. For example, in the case of a rhythm game, the cards are selected in rhythm to the music and switched to the rhythm. Alternatively, the cards are selected and switched when notes NTm are presented a given number of times or more. Alternatively, the cards are selected at times when a measure of music is over.

Furthermore, the time of selection is determined based on the action acquired. For example, in the case of the rhythm game, the cards are selected and switched when a given number of operations such as tapping and flicking operations are executed. Alternatively, the cards are selected and switched when a given number of proper operations are executed. Alternatively, the cards are selected and switched when a given number or more of operations or proper operations are executed within a given time period. Here, the given time period may be determined on the basis of measure of music.

In this embodiment, the process controller 11 functions as the selector 106. This applies to the embodiments below.

Then, the action presenter 104 presents the first and second objects along with the first and second actions.

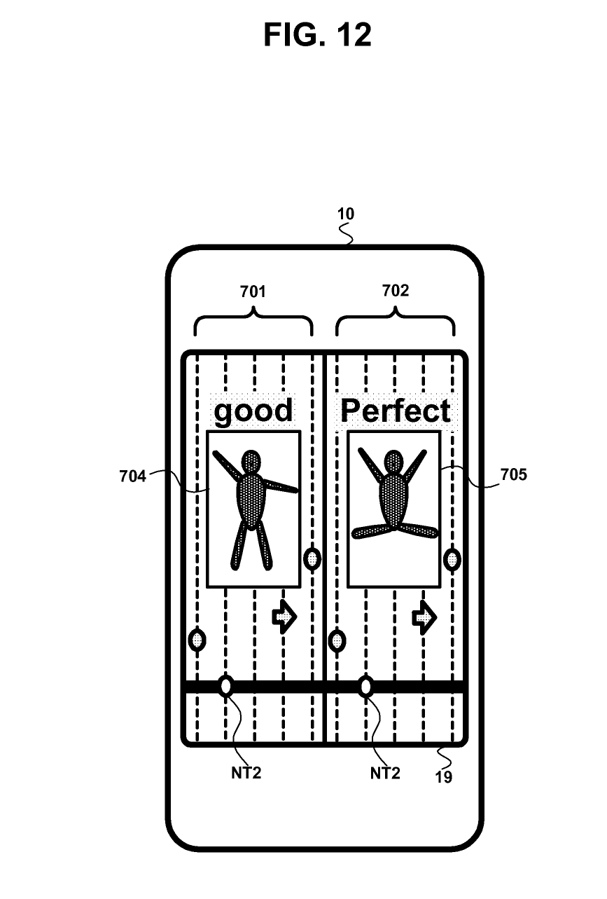

For example, it is assumed that the “CARD X” is selected for the user A and the “CARD W” is selected for the user B. The action presenter 104 presents the “CARD X” (a card 704) and “CARD W” (a card 705) along with the action data of the users to the note NTm as shown in FIG. 12.

The evaluator 107 determines an evaluation value of the first user and an evaluation value of the second user based on the first action and the first object and the second action and the second object.

For example, it is assumed that the user can earn a score ranging from “1” to “10” for his/her operation on a note NTm. If the user A's operation on the note NT2 earns a score “5,” the evaluation value of the user A is “9” since the “CARD X” selected for the user A has a score “4.” On the other hand, if the user B's operation on the note NT2 earns a score “6,” the evaluation value of the user B is “7” since the “CARD W” selected for the user B has a score “1.” The scores for the operations on all notes NTm and cards are obtained as described above until the end of music and added to obtain the evaluation values of the users.

Here, it is possible that a given parameter is set for the object and the evaluator 107 obtains the evaluation value based on the object parameter for the action taken while the object is presented.

For example, a parameter of a numeric value “2” is set for an object, and then the evaluator 107 multiplies the score of an action by “2” to obtain the evaluation value for the action taken while the object is presented. For example, the parameter is changed in each measure when the object is changed in each measure. In such a case, the evaluator 107 multiplies the scores of actions on the notes NTm in a measure by the value of the parameter in the measure to obtain the evaluation value.

In this embodiment, the process controller 11 functions as the evaluator 107. This applies to the embodiments below.

In this embodiment, the evaluation is based on the object associated with the user in addition to the action to the task, whereby a user who is not good at the task may win in competing with an experienced user. This prevents a beginner from being unwilling to compare and hesitating to participate in the game even if, for example, there is a significant difference in skill from a user who is available for comparison. Furthermore, the object is changed and the evaluation value is altered each time the task is executed. The user is urged to continuously work on a familiar task.

### Operation of Comparison Device According to Embodiment 2

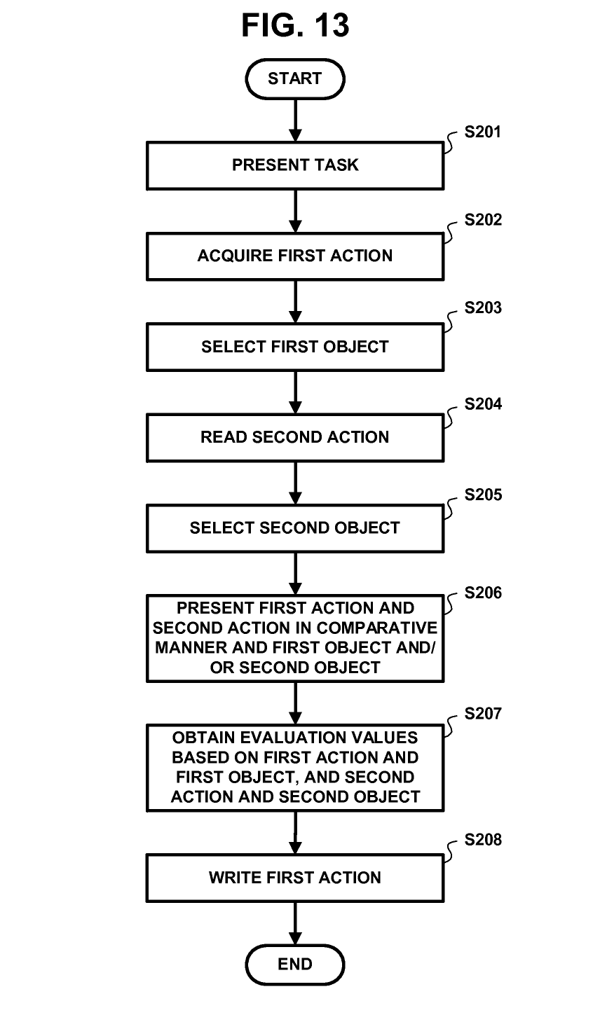

Operation of the comparison device 100 according to Embodiment 2 will be described hereafter. As the comparison device 100 is powered on, the comparison device 100 executes the procedure shown in the flowchart of FIG. 13. The processing in each step will be described hereafter. Here, the processing in Steps S201, S202, S204, and S208 is the same as that in the Steps S101 to S103 and S105 in the flowchart of FIG. 8 and its explanation is omitted.

As the first action is acquired in Step S202, the selector 106 selects the first object for the first user (Step S203). Here, this processing is executed in parallel to the processing in Step S202.

For example, the selector 106 makes reference to the object table 602a and selects a card randomly from the cards associated with the user A. Furthermore, the selector 106 selects a card again, for example, when the user A executes a given number of tapping operations.

As the second action is read from the storage 500 in Step S204, the selector 106 selects the second object for the second user (Step S205).

For example, the selector 106 makes reference to the object table 602a and selects a card from the cards associated with the user B in the ascending order of score at times when a given number of tapping operations are executed.

The action presenter 104 presents the selected first object along with the first action and the selected second object along with the second action (Step S206).

For example, the action presenter 104 presents the sequentially selected cards (“CARD X,” “CARD W,” and so on) along with the action data on the notes NTm as shown in FIG. 12.

The evaluator 107 determines the evaluation value of the first user based on the first action and the first object and the evaluation value of the second user based on the second action and the second object (Step S207).

For example, the evaluator 107 obtains the evaluation value based on the operation of the user A on the note NT2 and “CARD X” and the evaluation value based on the operation of the user B on the note NT2 and “CARD W.”

Here, the order of the processing executed by the comparison device 100 is not limited to the order shown in the flowchart of FIG. 13. For example, the processing of selecting the first object or the second object may be executed in real time when the action presenter 104 presents the first action/second action and the first object/second object together. Furthermore, for example, the processing of the evaluator 107 in the Step S207 may be executed prior to the processing of the action presenter 104 in the Step S206. Furthermore, for example, the writer 105 may write information on the selected first object or write the obtained evaluation value along with the first action in the Step S208. With such a configuration, upon reading the written data as the second action, the processing of selecting the second object for the second user and/or the processing of obtaining the evaluation value of the second user can be omitted.

### General Configuration of Comparison Device According to Embodiment 3

The comparison device 100 according to Embodiment 3 comprises, as shown in FIG. 4, a task presenter 101, an acquirer 102, a reader 103, an action presenter 104, and a writer 105.

The acquirer 102, the reader 103, and the writer 105 of this embodiment have the same functions as those of Embodiment 1. The task presenter 101 and the action presenter 104 having different functions will mainly be described hereafter.

The task comprises multiple ordered partial tasks.

For example, the task of the rhythm game comprises partial tasks including several measures. The partial task means the notes NTm included in a given number of measures (for example, four measures) in a rhythm game. Then, the task presenter 101 presents the notes NTm in every four measures to the user. Here, if the task is, for example, a medley of multiple kinds of pieces of music, the partial task can be each piece of music.

After the task presenter 101 presents the partial task, the action presenter 104 repeats the processing of presenting the parts of the first action and the second action that correspond to the partial task in the comparative manner.

For example, it is assumed that the notes NTm in the first four measures of the music of the rhythm game are presented, the user A executes operation on the notes NTm, and the acquirer 102 acquires the action data. The action presenter 104 presents the action data of the user A during the first four measures and the action data of the user B during the same music part in the comparative manner. Then, after the presentation of the four measures is over, the task presenter 101 presents the notes NTm in the next four measures. With the action data of the user A during the next four measures being acquired, the action presenter 104 presents the action data of the user A and the action data of the user B during the next four measures in the comparative manner. This processing is repeated until the music is over.

With this embodiment, the user can make a comparison with other user in the middle of action to the task and carry on the task while checking on the action of the other user. Then, the user can work on the task without being tired of it.

### Operation of Comparison Device According to Embodiment 3

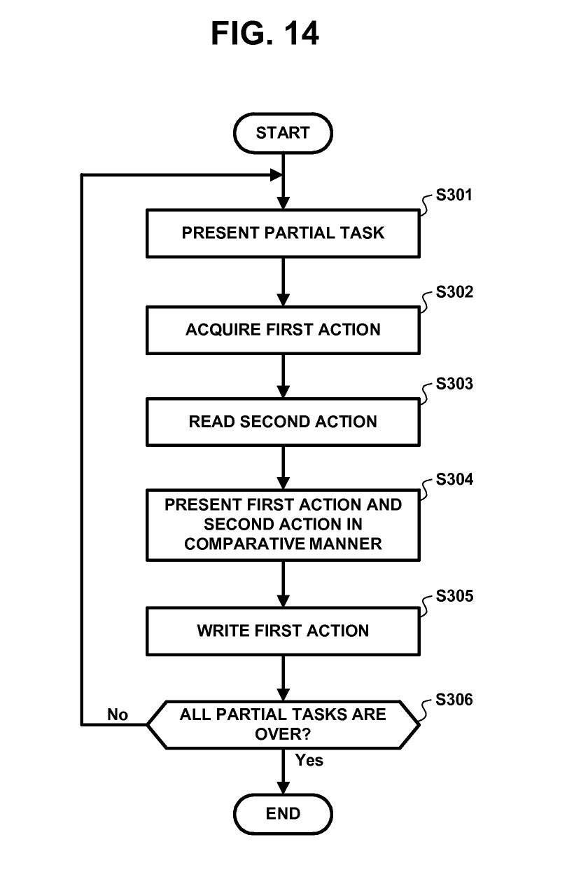

Operation of the comparison device 100 according to Embodiment 3 will be described hereafter. As the comparison device 100 is powered on, the comparison device 100 executes the procedure shown in the flowchart of FIG. 14. The processing in each step will be described hereafter.

The task presenter 101 presents the partial task (Step S301).

For example, the task presenter 101 presents the notes NTm in four measures of the music.

The acquirer 102 acquires the first action taken by the first user while the partial task is presented to the first user (Step S302).

For example, the acquirer 102 acquires information on the operation executed by the user A on the notes NTm in the four measures.

The reader 103 reads the action taken by the second user to the partial task (Step S303).

For example, the reader 103 reads information on the operation executed by the user B in regard to the four measures during which the user A executed the operation.

Then, the action presenter 104 presents the parts of the first action and the second action that correspond to the partial task in the comparative manner (Step S304).

For example, the action presenter 104 displays on the display 19 the action data of the user A during the four measures and the action data of the user B during the four measures in the comparative manner.

The writer 105 writes the first action taken by the first user to the partial task to the storage 500 (Step S305).

For example, the writer 105 writes information on the operation of the user A during the four measures to the storage 500.

Then, the process controller 11 determines whether all partial tasks are completed (Step S306). If the process controller 11 determines that all partial tasks are completed (Step S306; Yes), the procedure shown in FIG. 14 ends. On the other hand, if the process controller 11 determines that not all partial tasks are completed (Step S306; No), the processing is repeated from the Step S301.

Here, the order of the processing executed by the comparison device 100 is not limited to the order shown in the flowchart of FIG. 14. For example, it is possible that the reader 103 reads the entire second action to the task at the beginning and the action presenter 104 presents only the second action corresponding to the partial task. Furthermore, it is possible that the writer 105 writes the first action to the storage 500 after the entire task is over.

### General Configuration of Comparison Device According to Embodiment 4

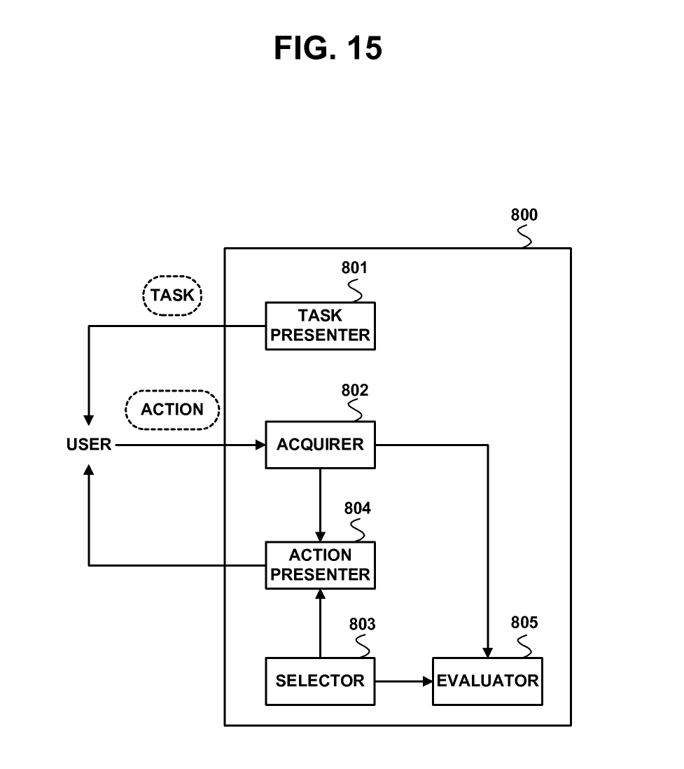

A comparison device 800 according to Embodiment 4 comprises, as shown in FIG. 15, a task presenter 801, an acquirer 802, a selector 803, an action presenter 804, and an evaluator 805.

The comparison device 800 of this embodiment determines an evaluation value of a user based on an action taken by the user and an object. In other words, the components are configured as follows.

The task presenter 801 presents a task to the user.

The acquirer 802 acquires the action taken by the user while the task is presented to the user.

The selector 803 selects the object for the user.

Here, the selector 803 selects the object from a group of objects associated with the user under a given rule. The given rule is random, the descending order of score set for the objects, the ascending order of the score, or a rule determined by the user as appropriate. Furthermore, the time when the selector 803 selects the object is determined based on the timing and quantity of the presented task, or the acquired action.

The action presenter 804 presents the acquired action and selected object to the user.

The evaluator 805 determines the evaluation value of the user based on the action and the object.

This embodiment obtains the evaluation value of the user based not only on the action of the user to the task but also on the object associated with the user, whereby the evaluation of the user can be changed. Furthermore, the selected object is changed and the evaluation value is altered each time the task is executed. The user can continue to work on a familiar task.

### Operation of Comparison Device According to Embodiment 4

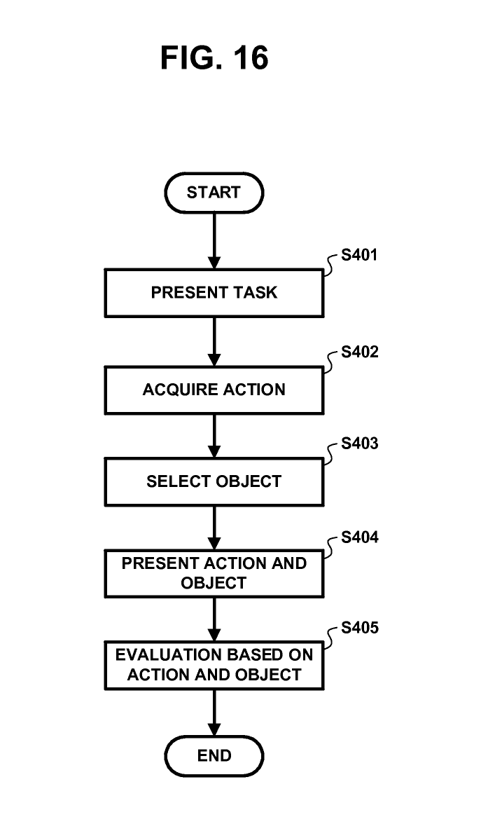

Operation of the comparison device 800 according to Embodiment 4 will be described hereafter. As the comparison device 800 is powered on, the comparison device 800 executes the procedure shown in the flowchart of FIG. 16.

As the user specifies a task, the task presenter 801 presents the task to the user (Step S401).

The acquirer 802 acquires the action taken by the user while the task is presented to the user (Step S402).

The selector 803 selects the object for the user (Step S403). Here, the processing of selecting the object is executed in parallel to the Step S402.

The action presenter 804 presents the selected object along with the action (Step S404).

The evaluator 805 determines the evaluation value of the user based on the action and the object (Step S405).

Here, the order of the processing executed by the comparison device 800 is not limited to the order shown in the flowchart of FIG. 16. For example, the processing in the Steps 404 and 405 can be executed in the opposite order.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

The present invention can provide a comparison device, comparison method, non-transitory recording medium, and system preferable for comparing the action of a user with the action of a third party.
1 System
200 Terminal device
300 Sever device
400 Internet
10 Information processing device
11 Process controller
11a CPU
11b Image processor
11c Sound processor
11d ROM
11e RAM
11f LCD controller
11g Touch panel controller
12 Wireless communicator
13 Communication controller
14 Sound amplifier
15 Speaker
16 Microphone
17 Operation key
18 Acceleration sensor
19 Display
20 Touch panel
21 Camera
100, 800 Comparison device
101, 801 Task presenter
102, 802 Acquirer
103 Reader
104, 804 Action presenter
105 Writer
106, 803 Selector
107, 805 Evaluator
500 Storage
NT1 to NT5 Note
SL Reference line
701, 702 Action data
703 Evaluation
704, 705 Card

What is claimed is:

1. A comparison device, comprising:
a task presenter presenting a task to a first user;
an acquirer acquiring a first action taken by the first user while the task is presented to the first user;
a reader reading a second action taken by a second user to the task from a storage;
an action presenter presenting the first action and the second action to the first user in a comparative manner; and
a writer writing to the storage the first action as the action taken by the first user to the task.

2. The comparison device according to claim 1, further comprising a selector selecting a first object for the first user and a second object for the second user, wherein:
the action presenter presents the first object and the second object along with the first action and the second action.

3. The comparison device according to claim 2, wherein:
the selector selects the first object from a group of first objects associated with the first user under a first rule, and
selects the second object from a group of second objects associated with the second user under a second rule.

4. The comparison device according to claim 2, further comprising
an evaluator determining an evaluation value of the first user and an evaluation value of the second user based on the first action and the first object and the second action and the second object.

5. The comparison device according to claim 1, wherein:
the task comprises multiple ordered partial tasks, and
the action presenter repeats the processing of presenting parts of the first action and the second action that correspond to a partial task in the comparative manner after the task presenter presents the partial task.

6. A comparison method executed by a comparison device comprising a task presenter, an acquirer, a reader, an action presenter, and a writer, comprising:
a task presentation step in which the task presenter presents a task to a first user;
an acquisition step in which the acquirer acquires a first action taken by the first user while the task is presented to the first user;
a reading step in which the reader reads a second action taken by a second user to the task from a storage;
an action presentation step in which the action presenter presents the first action and the second action to the first user in a comparative manner; and
a writing step in which the writer writes to the storage the first action as the action taken by the first user to the task.

7. A computer-readable non-transitory recording medium that records a program that allows a computer to function as:
a task presenter presenting a task to a first user;
an acquirer acquiring a first action taken by the first user while the task is presented to the first user;
a reader reading a second action taken by a second user to the task from a storage;
an action presenter presenting the first action and the second action to the first user in a comparative manner; and
a writer writing to the storage the first action as the action taken by the first user to the task.

8. A system including a terminal device and a server device communicable with the terminal device, wherein either the terminal device or the server device comprises:
a task presenter presenting a task to a first user;
an acquirer acquiring a first action taken by the first user while the task is presented to the first user;
a reader reading a second action taken by a second user to the task from a storage;
an action presenter presenting the first action and the second action to the first user in a comparative manner; and
a writer writing to the storage the first action as the action taken by the first user to the task.
